(19) United States
(12) Patent Application Publication
(10) Pub. No.: US 2025/0229649 A1
(43) Pub. Date: Jul. 17, 2025

(54) VEHICLE

(71) Applicant: SUBARU CORPORATION, Tokyo (JP)

(72) Inventor: Takahide ARAI, Tokyo (JP)

(21) Appl. No.: 18/974,985

(22) Filed: Dec. 10, 2024

(30) Foreign Application Priority Data
Jan. 16, 2024 (JP) 2024-004418

(51) Int. Cl. B60L 50/64; B60R 21/00; B60R 21/013; B62D 21/15; H01M 50/242; H01M 50/249

(52) U.S. Cl. CPC B60L 50/64; B60R 21/013; B62D 21/157; H01M 50/242; H01M 50/249; B60R 2021/0006; H01M 2220/20

(57) ABSTRACT

A vehicle includes battery modules, a battery case, a collision sensor, and a disabling mechanism. The battery modules each include battery cells and a binder. The binder binds the battery cells. The battery case houses the battery modules. The collision sensor is configured to perform a detection of a collision of the vehicle. The disabling mechanism is configured to disable the binder from binding the battery cells in response to the detection of the collision by the collision sensor. The battery modules in the battery case are configured to be spaced apart from each other in a direction of the collision of the vehicle such that a space is provided between the battery modules. The space allows the battery cells to move when the binder is disabled from binding the battery cells.

### CROSS-REFERENCE TO RELATED APPLICATIONS

The present application claims priority from Japanese Patent Application No. 2024-004418 filed on Jan. 16, 2024, the entire contents of which are hereby incorporated by reference.

### BACKGROUND

The disclosure relates to a vehicle.

Some known vehicles each include a motor for traveling, and a battery configured to supply electric power to the motor for traveling. In many cases, the battery intended for a vehicle is a liquid-based battery such as a lithium (Li)-ion battery. If the Li-ion battery receives a collision load or an impact in, for example, a vehicle accident or the like, the Li-ion battery may be deformed or damaged and may cause an internal short circuit. In such an event, the Li-ion battery may cause thermal runaway and catch fire or burst, leading to a vehicle fire.

To prevent such a vehicle fire, an exemplary technique is disclosed in Japanese Unexamined Patent Application Publication (Translation of PCT Application) (JP-T) No. 2014-517986, in which a dispenser configured to dispense an agent such as a flame inhibitor, a flame retardant, or a flame extinguisher is disposed in a space provided inside a battery case. According to JP-T No. 2014-517986, multiple battery cells are housed in the battery case, and the dispenser has openings that are located adjacent to the respective battery cells. In the event of a vehicle accident, the agent such as a flame inhibitor, a flame retardant, or a flame extinguisher is dispensed through the openings of the dispenser toward the respective battery cells to prevent a vehicle fire.

### SUMMARY

An aspect of the disclosure provides a vehicle including battery modules, a battery case, a collision sensor, and a disabling mechanism. The battery modules each include battery cells and a binder. The binder binds the battery cells. The battery case houses the battery modules. The collision sensor is configured to perform a detection of a collision of the vehicle. The disabling mechanism is configured to disable the binder from binding the battery cells in response to the detection of the collision of the vehicle by the collision sensor. The battery modules in the battery case are configured to be spaced apart from each other in a direction of the collision of the vehicle such that a space is provided between the battery modules. The space allows the battery cells to move when the binder is disabled from binding the battery cells.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a side view of a vehicle according to an embodiment, illustrating a configuration thereof;

FIG. 2 is a perspective view of a battery pack according to the embodiment;

FIG. 3 is a perspective view of a battery module according to the embodiment;

FIG. 4 is a perspective view of an exemplary binder according to the embodiment;

FIG. 5 is an enlarged view of the binder according to the embodiment, illustrating a fragile part thereof;

FIG. 6 is a perspective view of an exemplary disabling mechanism according to the embodiment;

FIG. 7 is a block diagram illustrating a configuration of the vehicle according to the embodiment;

FIG. 8 is a block diagram illustrating a functional configuration of a controller according to the embodiment;

FIG. 9 illustrates the inside of the battery pack at the moment of a side-on collision of the vehicle according to the embodiment; and

FIG. 10 illustrates the inside of the battery pack as a result of the side-on collision of the vehicle according to the embodiment.

### DETAILED DESCRIPTION

The technique disclosed in JP-T No. 2014-517986 is not necessarily intended to suppress the deformation of or damage to the battery cells that may lead to a vehicle fire. Therefore, regions of the battery cells excluding regions facing the openings of the dispenser may be deformed or damaged. If the agent such as a flame inhibitor, a flame retardant, or a flame extinguisher is not supplied to the deformed or damaged regions, a vehicle fire may occur.

It is desirable to provide a vehicle in which battery cells are less likely to be deformed or damaged.

An embodiment of the disclosure will now be described in detail with reference to the accompanying drawings. Any dimensions, materials, numerical values, and other relevant factors given in the following embodiment are only provided as examples for ease of understanding of the disclosure, and do not limit the disclosure unless otherwise stated. In this specification and the drawings, elements having substantially the same functions or configurations are denoted by the same reference signs, so that redundant description of such elements is omitted. Elements irrelevant to the disclosure are not illustrated.

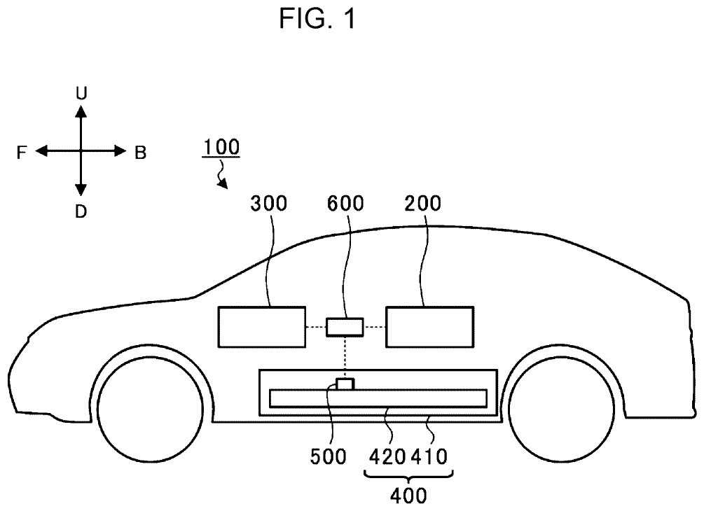

FIG. 1 is a side view of a vehicle 100 according to an embodiment, illustrating a configuration thereof. In FIG. 1, the upper, lower, front, and rear sides of the vehicle 100 are represented by respective arrows. In FIG. 1, arrow F represents the front side, or the forward direction, of the vehicle 100; arrow B represents the rear side, or the backward direction, of the vehicle 100; arrow U represents the upper side of the vehicle 100; and arrow D represents the lower side of the vehicle 100.

The vehicle 100 includes a collision sensor 200, an airbag 300, a battery pack 400, a disabling mechanism 500, and a controller 600.

The collision sensor 200 is configured to detect a collision of the vehicle 100. The collision sensor 200 is disposed on, for example, each of the doors on the left and right sides of the vehicle 100. A collision load generated in the event of a side-on collision of the vehicle 100 moves the collision sensor 200. With reference to the acceleration of the collision sensor 200, the occurrence of the side-on collision of the vehicle 100 is detected. The following description relates to, but is not limited to, an exemplary case where the collision sensor 200 is configured to detect a side-on collision of the vehicle 100. The collision sensor 200 may alternatively be configured to detect a head-on collision or rear-end collision of the vehicle 100.

The airbag 300 is, for example, a side airbag intended for an impact that may be applied from a lateral side, that is, in the left-right direction, of the vehicle 100. The airbag 300 includes an igniter (not illustrated) and a gas generator (not illustrated). In the event of a side-on collision of the vehicle 100, the igniter of the airbag 300 ignites the gas generator. When the gas generator is ignited by the igniter, the gas generator generates gas to inflate the airbag 300. The airbag 300 thus inflated protects the body of an occupant in the vehicle 100. The following description relates to, but is not limited to, an exemplary case where the airbag 300 is a side airbag. The airbag 300 may be any airbag that is at least inflatable in the cabin of the vehicle 100. The position, size, range, and other relevant factors of the airbag 300 to be installed are not limited.

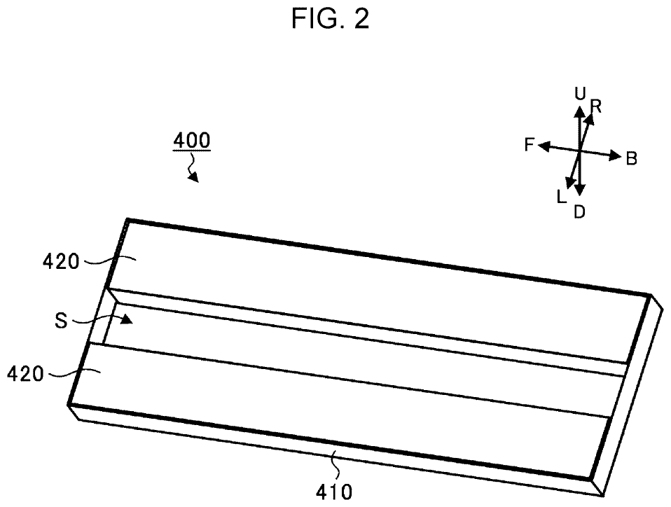

FIG. 2 is a perspective view of the battery pack 400 according to the present embodiment. In FIG. 2, arrow F represents the front side, or the forward direction, of the vehicle 100; arrow B represents the rear side, or the backward direction, of the vehicle 100; arrow R represents the right side of the vehicle 100; arrow L represents the left side of the vehicle 100; arrow U represents the upper side of the vehicle 100; and arrow D represents the lower side of the vehicle 100.

The battery pack 400 is disposed at, for example, a lower central part of the body of the vehicle 100, as illustrated in FIG. 1. As illustrated in FIGS. 1 and 2, the battery pack 400 includes a battery case 410 and multiple battery modules 420. The battery case 410 houses the battery modules 420. In the present embodiment, two battery modules 420 are housed. As illustrated in FIG. 2, the two battery modules 420 in the battery case 410 are spaced apart from each other in the left-right direction. That is, a space S is provided between the two battery modules 420. Note that the number of the battery modules 420 is not limited to two and may be three or more. If three or more battery modules 420 are to be housed, the battery modules 420 may be arranged side by side in both the left-right direction and the front-rear direction. In the front-rear direction, the battery modules 420 may be arranged with a space S therebetween or may adjoin each other.

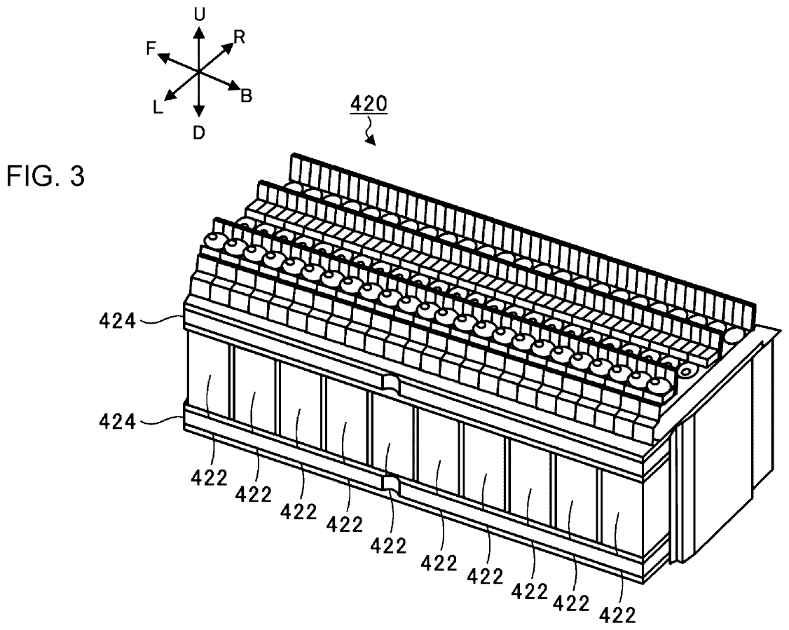

FIG. 3 is a perspective view of one of the battery modules 420 according to the present embodiment. As illustrated in FIG. 3, each battery module 420 includes multiple battery cells 422 and a binder 424.

The battery cells 422 are each, for example, a lithium-ion battery cell or the like and is a secondary battery that is chargeable and dischargeable. The battery cells 422 each have, for example, a cuboidal shape. The vehicle 100 includes a motor (not illustrated) as a drive source for traveling. The battery cells 422 are configured to supply electric power to the motor. In the present embodiment, the vehicle 100 is an electric vehicle or a hybrid electric vehicle.

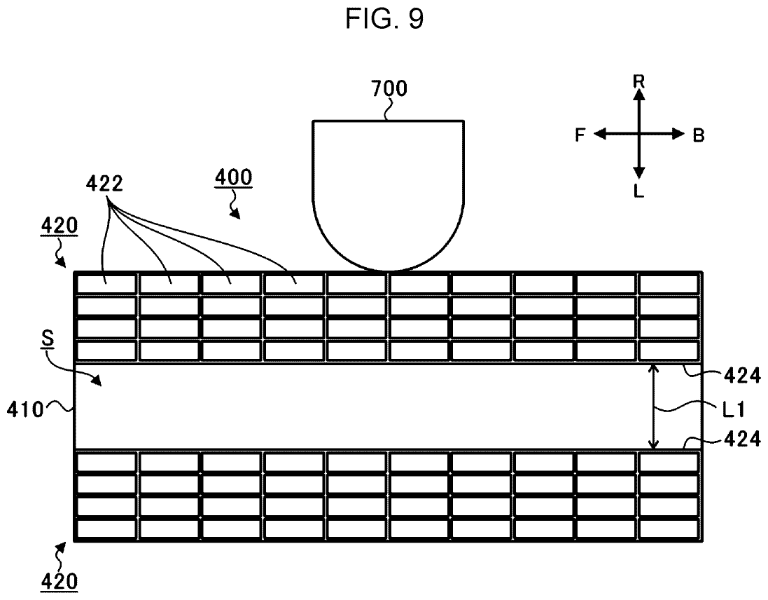

As to be described in detail below with reference to FIG. 9, the multiple battery cells 422 are arranged parallel to each other in the front-rear direction and in the left-right direction. For example, a single battery module 420 is constituted by ten sets of four battery cells 422, with each four battery cells 422 being side by side in the left-right direction and the ten sets of battery cells 422 being parallel to each other in the front-rear direction.

The binder 424 binds the multiple battery cells 422 altogether. In the example illustrated in FIG. 3, a pair of binders 424 are disposed at respective positions in the up-down direction of the battery cells 422. Thus, the multiple battery cells 422 are bound by the multiple binders 424. Note that the number of the binders 424 that bind the multiple battery cells 422 is not limited to the above and may be one.

The binder 424 extends around the lateral faces of all of the battery cells 422 included in a single battery module 420. The binder 424 restrains the battery cells 422 from moving in the left-right direction and in the front-rear direction.

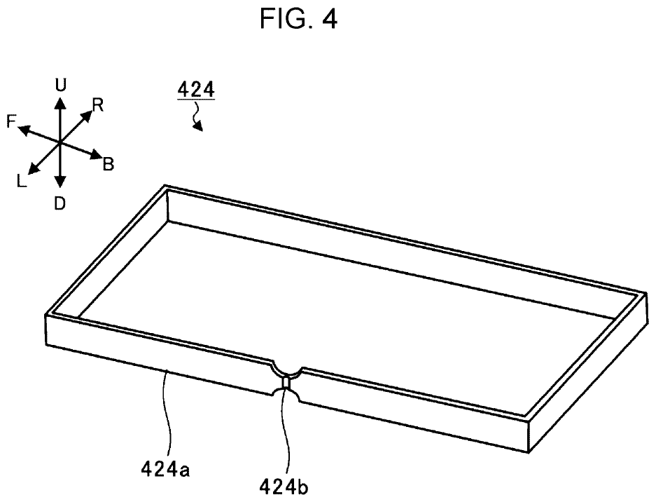

FIG. 4 is a perspective view of an exemplary binder 424 according to the present embodiment. As illustrated in FIG. 4, the binder 424 has a rectangular frame shape. The binder 424 includes a body 424a and a fragile part 424b. The body 424a is a rectangular frame. The fragile part 424b is a part of the body 424a serving as a rectangular frame and has a lower strength than the body 424a. Thus, the binder 424 according to the present embodiment includes the fragile part 424b having a lower strength than the other part of the binder 424.

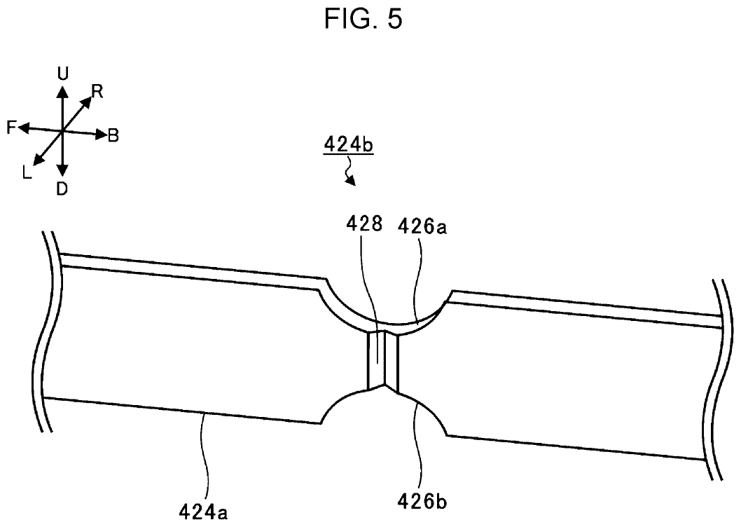

FIG. 5 is an enlarged view of the binder 424 according to the present embodiment, illustrating the fragile part 424b thereof. As illustrated in FIG. 5, the fragile part 424b is constituted by a pair of semicircular indentations 426a and 426b, and a V-shaped groove 428.

The indentation 426a is provided at an end of the binder 424 that is on the upper side U. The indentation 426b is provided at an end of the binder 424 that is on the lower side D. The indentation 426a and the indentation 426b are separate from each other in the up-down direction and are located side by side in the up-down direction.

The groove 428 is provided between the pair of indentations 426a and 426b. The groove 428 extends in the up-down direction in such a manner as to connect the apexes of the pair of semicircular indentations 426a and 426b to each other. In the example illustrated in FIG. 5, the inner lateral surface of the binder 424 that faces toward the right side R is to receive the battery cells 422, and the outer lateral surface of the binder 424 that faces toward the left side L has the groove 428.

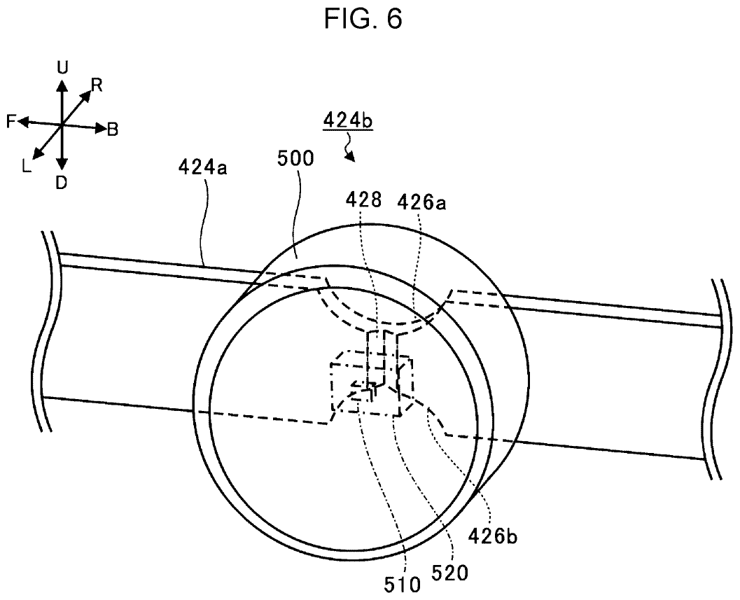

FIG. 6 is a perspective view of an exemplary disabling mechanism 500 according to the present embodiment. The disabling mechanism 500 according to the present embodiment is, for example, an inflator. As illustrated in FIG. 6, the disabling mechanism 500 is disposed facing the groove 428 provided at the fragile part 424b of the binder 424.

The disabling mechanism 500 includes an igniter 510 and a gas generator 520. The igniter 510 is configured to ignite the gas generator 520. When the gas generator 520 is ignited by the igniter 510, the gas generator 520 generates gas. The gas thus generated by the gas generator 520 is blown at a high speed toward the groove 428 provided at the fragile part 424b of the binder 424. The pressure of the gas generated by the gas generator 520 breaks the fragile part 424b at the groove 428. Thus, the binder 424 is disabled from binding the battery cells 422.

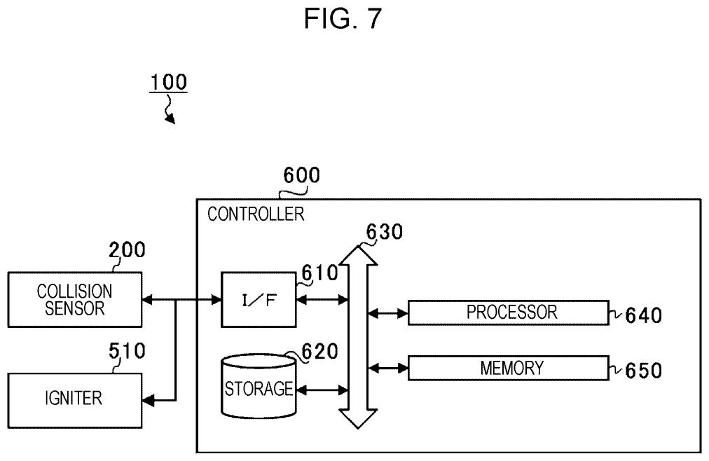

FIG. 7 is a block diagram illustrating a configuration of the vehicle 100 according to the present embodiment. The controller 600 according to the present embodiment is configured to control the ignition of the igniter 510 of the disabling mechanism 500 in response to the collision sensor 200 detecting a collision of the vehicle 100. The controller 600 includes an interface (I/F) 610, a storage 620, a system bus 630, at least one processor 640, and at least one memory 650. The I/F 610 is intended for communication with the collision sensor 200 and the igniter 510. For example, the I/F 610 is configured to acquire data transmitted from the collision sensor 200. Furthermore, the I/F 610 is configured to transmit to the igniter 510 a control signal that is a control command for the igniter 510 to ignite the gas generator 520.

The storage 620 includes any of a random access memory (RAM), a flash memory, a hard disk drive (HDD), and the like and is configured to store various kinds of information that are necessary for processing operations of the processor 640 to be described below. The system bus 630 electrically couples the I/F 610, the storage 620, the processor 640, and the memory 650 to each other and serves as a transmission line for data transmission therebetween.

The processor 640 includes, for example, a central processing unit (CPU). The memory 650 includes, for example, any of a read-only memory (ROM), a random access memory (RAM), and the like. The ROM is a storage cell configured to store programs, arithmetic parameters, and so forth to be used by the CPU. The RAM is a storage cell configured to temporarily store data such as variables and parameters for processing operations to be executed by the CPU.

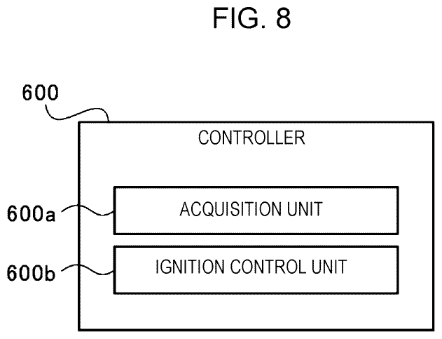

FIG. 8 is a block diagram illustrating a functional configuration of the controller 600 according to the present embodiment. As illustrated in FIG. 8, the controller 600 includes, for example, an acquisition unit 600a and an ignition control unit 600b.

The processor 640 is configured to cooperate with programs stored in the memory 650 and to execute the programs stored in the memory 650, thereby implementing relevant processing operations, including those to be performed by the acquisition unit 600a and the ignition control unit 600b, which will be described separately below.

The acquisition unit 600a is configured to acquire data transmitted from the collision sensor 200. The ignition control unit 600b is configured to control the ignition of the igniter 510 with reference to the data acquired by the acquisition unit 600a. A control operation to be performed by the ignition control unit 600b will be described in detail separately below.

In many cases, the battery to be included in a vehicle is a liquid-based battery such as a Li-ion battery. If the Li-ion battery receives a collision load or an impact in, for example, a vehicle accident or the like, the Li-ion battery may be deformed or damaged and may cause an internal short circuit. In such an event, the Li-ion battery may cause thermal runaway and catch fire or burst, leading to a vehicle fire.

In view of such circumstances, the battery module 420 according to the present embodiment includes the disabling mechanism 500 configured to disable the binder 424 from binding the multiple battery cells 422 in response to the collision sensor 200 detecting a collision of the vehicle 100. Now, an operation of the disabling mechanism 500 in the event of a collision of the vehicle 100 will be described in detail.

First, if the vehicle 100 collides against something and receives a collision load, the collision sensor 200 detects the occurrence of a collision of the vehicle 100 with reference to the acceleration of the collision sensor 200 and transmits to the controller 600 a detection signal that reports the occurrence of a collision of the vehicle 100.

The detection signal thus transmitted from the collision sensor 200 is acquired by the acquisition unit 600a of the controller 600. In response to the acquisition of the detection signal by the acquisition unit 600a, the ignition control unit 600b transmits to the igniter 510 of the disabling mechanism 500 an ignition signal that is a control command for igniting the gas generator 520.

In response to the ignition signal received from the ignition control unit 600b, the igniter 510 ignites the gas generator 520. When the gas generator 520 is ignited by the igniter 510, the gas generator 520 generates gas. The gas thus generated by the gas generator 520 is blown at a high speed toward the groove 428 provided at the fragile part 424b of the binder 424. The pressure of the gas generated by the gas generator 520 breaks the fragile part 424b at the groove 428. Thus, the binder 424 is disabled from binding the battery cells 422.

FIG. 9 illustrates the inside of the battery pack 400 at the moment of a side-on collision of the vehicle 100 according to the present embodiment. FIG. 9 illustrates a moment when an object 700 collides against a lateral face of the body of the vehicle 100 from the right side R of the vehicle 100. That is, FIG. 9 illustrates a case where the direction of collision is the left-right direction of the vehicle 100. Note that the direction of collision may be the front-rear direction of the vehicle 100 or may be both the left-right direction and the front-rear direction.

In the case illustrated in FIG. 9, two battery modules 420 are disposed in the battery case 410 in such a manner as to be spaced apart from each other in the left-right direction defined as the direction of collision. The number of the battery modules 420 disposed in the battery case 410 is not limited to two and may be three or more. In that case, the three or more battery modules 420 in the battery case 410 are spaced apart from each other in the left-right direction defined as the direction of collision.

If the direction of collision is the front-rear direction, three or more battery modules 420 are disposed in the battery case 410 in such a manner as to be spaced apart from each other in the front-rear direction defined as the direction of collision. If the direction of collision is both the front-rear direction and the left-right direction, three or more battery modules 420 are disposed in the battery case 410 in such a manner as to be spaced apart from each other in the front-rear direction and the left-right direction both defined as the direction of collision.

As illustrated in FIG. 9, the two battery modules 420 in the battery case 410 are spaced apart from each other at a predetermined interval L1 in the left-right direction defined as the direction of collision of the vehicle 100. The predetermined interval L1 is greater than or equal to the amount of deformation that is undergone by the battery case 410 when an object 700 collides against the vehicle 100 in the left-right direction defined as the direction of collision. Since the multiple battery modules 420 are spaced apart from each other with the predetermined interval L1 in between, a space S is provided between the multiple battery modules 420 such that the battery cells 422 are allowed to move when unbound by the binder 424.

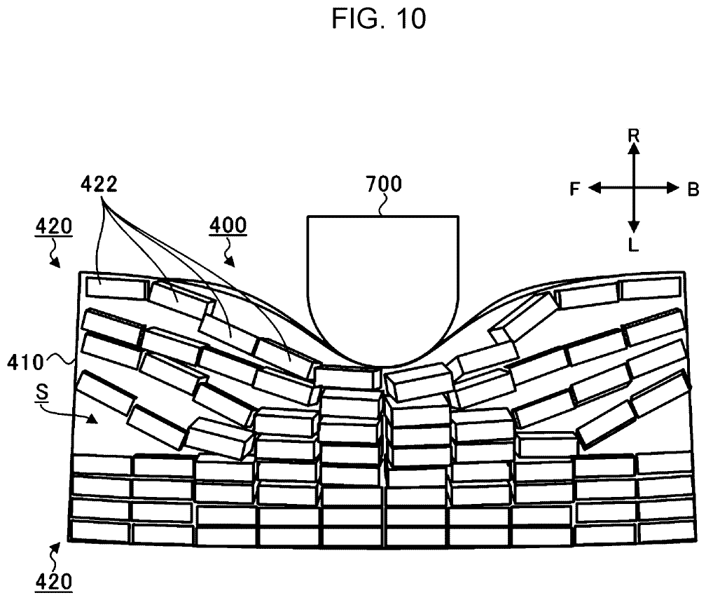

FIG. 10 illustrates the inside of the battery pack 400 as a result of the side-on collision of the vehicle 100 according to the present embodiment. As illustrated in FIG. 10, if an object 700 collides against the vehicle 100 in the left-right direction, the battery case 410 is deformed in the left-right direction under the collision load applied from the object 700. In the case illustrated in FIG. 10, a central part of one of the sidewalls of the battery case 410 that is on the right side R is deformed in such a manner as to be depressed toward the left side L under the collision load applied from the object 700.

At the collision of the object 700 against the vehicle 100, the collision sensor 200 detects the collision of the vehicle 100. In response to the detection of the collision of the vehicle 100, the ignition control unit 600b controls the igniter 510 of the disabling mechanism 500 to ignite the gas generator 520. Thus, the binder 424 is broken at the groove 428, whereby the binder 424 is disabled from binding the battery cells 422. Therefore, the battery cells 422 in the battery modules 420 are unbound by the binder 424 and are allowed to move freely in the space S provided inside the battery case 410.

Accordingly, even if an object 700 pushes the right sidewall of the battery case 410 in such a manner as to depress the right sidewall toward the left side L by an amount corresponding to the predetermined interval L1 as illustrated in FIG. 10, the battery cells 422 are less likely to be squashed by the object 700. That is, the battery cells 422 are less likely to be deformed or damaged. Consequently, the battery cells 422 are less likely to catch fire or burst. Thus, the probability of a vehicle fire is reduced.

According to the above embodiment, the vehicle 100 includes the disabling mechanism 500 configured to disable the binder 424 from binding the battery cells 422 in response to the collision sensor 200 detecting a collision of the vehicle 100. Furthermore, the battery modules 420 in the battery case 410 are spaced apart from each other in the direction of collision of the vehicle 100. Furthermore, between the battery modules 420 that are spaced apart from each other is provided the space S that allows the battery cells 422 to move when the binder 424 is disabled from binding the battery cells 422. Therefore, in the event of a collision of the vehicle 100, the battery cells 422 are less likely to be deformed or damaged. Consequently, the probability of a vehicle fire is reduced.

The binder 424 includes the fragile part 424b having a lower strength than the other part of the binder 424. At the receipt of a detection signal from the collision sensor 200, the igniter 510 of the disabling mechanism 500 ignites the gas generator 520 to break the fragile part 424b of the binder 424, whereby the binder 424 is disabled from biding the battery cells 422. Since the binder 424 includes the fragile part 424b, the binder 424 is more easily disabled from binding the battery cells 422 than in a case where the binder 424 includes no fragile part 424b.

The fragile part 424b has the groove 428. The disabling mechanism 500 includes the inflator disposed facing the groove 428 of the fragile part 424b. The disabling mechanism 500 is configured to disable the binder 424 from binding the battery cells 422 by breaking the fragile part 424b at the groove 428 with the use of the pressure of the gas generated by the inflator in response to the detection of a collision of the vehicle 100. Since the fragile part 424b has the groove 428 toward which the inflator faces, the binder 424 is easily breakable by using the pressure of the gas blown from the inflator.

The battery modules 420 in the battery case 410 are spaced apart from each other at the predetermined interval L1 in the left-right direction defined as the direction of collision of the vehicle 100. The predetermined interval L1 is greater than or equal to the amount of deformation that is undergone by the battery case 410 of the battery pack 400 when an object 700 collides against the vehicle 100 in the left-right direction of the vehicle 100. Therefore, even if an object 700 pushes the battery case 410 in the left-right direction by an amount corresponding to the predetermined interval L1, the battery cells 422 are less likely to be squashed by the object 700 and are allowed to move freely in the space S provided inside the battery case 410. Consequently, in the event of a side-on collision of the vehicle 100, the battery cells 422 are less likely to be deformed or damaged.

The collision sensor 200 is a sensor for the side airbag 300 disposed in the vehicle 100. That is, the sensor for causing the disabling mechanism 500 to disable the binder 424 from binding the battery cells 422 may also serve as a sensor intended for the side airbag 300. Such a sensor removes the necessity of providing an exclusive sensor for causing the disabling mechanism 500 to disable the binder 424 from binding the battery cells 422, and makes the configuration of the vehicle 100 less complicated.

While an embodiment of the disclosure has been described above with reference to the accompanying drawings, the disclosure is not limited to the above embodiment, of course. It is obvious to those skilled in the art that various changes and modifications are conceivable within the scope of the appended claims. It is to be understood that such changes and modifications are naturally within the technical scope of the disclosure.

While the above embodiment relates to a case where the fragile part 424b is included in the binder 424, the fragile part 424b may be omitted as long as the disabling mechanism 500 is capable of disabling the binder 424 from binding the battery cells 422.

While the above embodiment relates to a case where the fragile part 424b of the binder 424 has the indentations 426a and 426b and the groove 428, the fragile part 424b is not limited thereto. The fragile part 424b may have none of the indentations 426a and 426b and the groove 428. For example, the fragile part 424b may be made of a material having a lower strength than the material for the body 424a. Alternatively, the fragile part 424b may have no groove 428 but the indentations 426a and 426b. As another alternative, the fragile part 424b may have none of the indentations 426a and 426b but the groove 428.

While the above embodiment relates to a case where the disabling mechanism 500 includes the inflator, the disabling mechanism 500 is not limited thereto. The disabling mechanism 500 may include no inflator. In that case, for example, the disabling mechanism 500 may include a hydraulic, pneumatic, or electromagnetic actuator and be configured to disable the binder 424 from binding the battery cells 422 by applying an impact to the fragile part 424b of the binder 424 with the use of the actuator.

While the above embodiment relates to a case where the collision sensor 200 also serves as a sensor for the side airbag, the collision sensor 200 is not limited thereto. The collision sensor 200 may be provided separately from the sensor for the side airbag.

1. A vehicle comprising:
battery modules each comprising battery cells and a binder, the binder binding the battery cells;
a battery case housing the battery modules;
a collision sensor configured to perform a detection of a collision of the vehicle; and
a disabling mechanism configured to disable the binder from binding the battery cells in response to the detection of the collision of the vehicle by the collision sensor,
wherein the battery modules in the battery case are configured to be spaced apart from each other in a direction of the collision of the vehicle such that a space is provided between the battery modules, the space allowing the battery cells to move when the binder is disabled from binding the battery cells.

2. The vehicle according to claim 1,
wherein the binder comprises a fragile part having a lower strength than a part of the binder other than fragile part, and
wherein the disabling mechanism is configured to disable the binder from binding the battery cells by breaking the fragile part of the binder in response to the detection of the collision of the vehicle.

3. The vehicle according to claim 2,
wherein the fragile part has a groove, and
wherein the disabling mechanism comprises an inflator disposed facing the groove of the fragile part and is configured to, in response to the detection of a collision of the vehicle, disable the binder from binding the battery cells by breaking the fragile part at the groove with a use of a pressure of gas generated by the inflator.

4. The vehicle according to claim 1,
wherein the battery modules in the battery case are spaced apart from each other at a predetermined interval in a left-right direction of the vehicle, and
wherein the predetermined interval is greater than or equal to an amount of deformation that is undergone by the battery case when an object collides against the vehicle in the left-right direction of the vehicle.

5. The vehicle according to claim 2,
wherein the battery modules in the battery case are spaced apart from each other at a predetermined interval in a left-right direction of the vehicle, and
wherein the predetermined interval is greater than or equal to an amount of deformation that is undergone by the battery case when an object collides against the vehicle in the left-right direction of the vehicle.

6. The vehicle according to claim 3,
wherein the battery modules in the battery case are spaced apart from each other at a predetermined interval in a left-right direction of the vehicle, and
wherein the predetermined interval is greater than or equal to an amount of deformation that is undergone by the battery case when an object collides against the vehicle in the left-right direction of the vehicle.

7. The vehicle according to claim 1,
wherein the collision sensor is a sensor for a side airbag disposed in the vehicle.

8. The vehicle according to claim 2,
wherein the collision sensor is a sensor for a side airbag disposed in the vehicle.

9. The vehicle according to claim 3,
wherein the collision sensor is a sensor for a side airbag disposed in the vehicle.
